(19) United States
(12) Patent Application Publication
(10) Pub. No.: US 2002/0057480 A1
(43) Pub. Date: May 16, 2002

(54) Optical receiver for optical communications

(76) Inventor: Toshitaka Ushiyama, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/880,009

(22) Filed: Jun. 14, 2001

(30) Foreign Application Priority Data
Nov. 14, 2000 (JP) 2000-346775

(51) Int. Cl. H04B 10/06

(52) U.S. Cl. 359/194; 359/189

(57) ABSTRACT

An optical receiver achieving an approximately linear transition of an APD current with respect to an optical input intensity includes a threshold voltage control circuit for controlling an operation threshold voltage of an AGC amplifier control circuit and an operation threshold voltage of an APD bias voltage control circuit such that the APD current makes a linear transition with respect to the intensity of optical input.

### BACKGROUND OF THE INVENTION

1. Field of the Invention

The present invention relates to an optical receiver for optical communications.

2. Description of the Related Art

FIG. 7 is a diagram illustrating a conventional optical receiver generally used in optical communications. FIG. 7 shows an avalanche photo diode (APD) 1 serving as a light receiving element, an automatic gain control (AGC) amplifier 2 capable of adjusting the gain by receiving a control voltage from outside, a clock regeneration circuit 3 for regenerating a clock in accordance with an operation speed of an input signal, a peak detecting circuit 4 for detecting the peak of a signal output from the AGC amplifier 2 and converting it to a direct current voltage, an AGC amplifier control circuit 5 for adjusting the control voltage for the AGC amplifier 2 based on a voltage output from the peak detecting circuit 4, an APD bias voltage control circuit 6 for adjusting an APD bias voltage based on the voltage output from the peak detecting circuit 4, an APD bias voltage supplying circuit 7 for supplying the bias voltage to the APD 1, and an optical input intensity monitoring circuit 8 for supplying a voltage corresponding to a current running through the APD.

Operation of the above-described elements will next be described. The APD 1 is a semiconductor element for generating a current corresponding to the input optical intensity. To account for low intensity optical inputs, an amplifier is provided between the clock regeneration circuit 3 and the APD 1 so as to amplify the signal output from the APD 1 to the input sensitivity level of the circuit 3. When the input optical intensity is adequate, the signal output from the APD 1 is strong, and, therefore, the gain of the amplifier must be reduced to avoid excessive gain. The AGC amplifier 2 is used for this purpose. The gain of the AGC amplifier 2 can be controlled by the AGC amplifier control circuit 5 for adjusting the AGC amplifier control voltage based on the voltage output from the peak detecting circuit 4 for detecting the peak of the amplifier output signal and converting it to a direct current voltage. Further, the APD bias voltage control circuit 6 for performing feedback control on the APD bias voltage supplying circuit 7 based on the voltage output from the peak detecting circuit 4 is operated to control so that the ratio of increase in current of the APD 1 is enhanced when the optical input intensity becomes smaller, thereby optimizing the overall signal level. The optical input intensity monitoring circuit 8 is a circuit for producing a voltage output based on a potential difference generated at opposing ends of a resistor when a current through the APD 1 flows through the resistor.

The above-described conventional optical receiver has drawbacks such as that, when the entire control system is constructed using the above AGC amplifier control circuit and the APD bias voltage control circuit, different operational thresholds are usually set for the AGC amplifier control circuit and the APD bias voltage control circuit with respect to the voltage output from the peak detecting circuit in order to obtain the optical input intensity—control voltage characteristics illustrated in FIG. 4. Referring to FIG. 4, a line (a) indicates transition of the AGC amplifier control voltage, and a line (b) indicates transition of the APD bias control voltage. The gain of the AGC amplifier is adjusted by the AGC amplifier control circuit for a range where the optical input intensity is greater. When the optical input intensity becomes lower than a certain level, operations of the AGC amplifier control circuit and the APD bias voltage control circuit are switched, so that the APD bias voltage is adjusted by the APD bias voltage control circuit until the optical input intensity reaches a very small value range, thereby optimizing the overall signal level. Ideally, when the optical input intensity monitoring circuit for providing a voltage corresponding to the optical input intensity based on the APD current is constructed, the APD current should consistently transition in a linear manner with respect to the optical input intensity as indicated by the straight line (b) in FIG. 5. However, in conventional optical receivers, the APD bias voltage control circuit begins to operate in a manner such that the APD current increase ratio is enhanced when the optical input intensity reaches a control switching point. As a result, while the APD current exhibits a change in proportion to the optical input intensity where the optical input intensity is greater, the APD current shows a non-linear transition as the optical input intensity decreases as indicated by the line (a) in FIG. 5. Thus, the characteristics of the APD current exhibiting a linear transition cannot be obtained for a wide range of optical input levels.

### SUMMARY OF INVENTION

The present invention has been conceived in view of the above-described problems, and an object thereof is to provide an optical receiver allowing an approximately linear transition of the APD current with respect to the optical input intensity to be achieved, and an optical input intensity monitoring circuit operating in a wide range to be easily implemented.

An optical receiver according to one aspect of the present invention includes an avalanche photo diode (APD) for providing a current corresponding to an optical input intensity, an automatic gain control (AGC) amplifier for amplifying an output of the APD, a peak detecting circuit for detecting a peak of a signal output from the AGC amplifier, an AGC amplifier control circuit for adjusting a gain of the AGC amplifier based on an output from the peak detecting circuit, an APD bias voltage control circuit for supplying a bias voltage to the APD based on the output from the peak detecting circuit, and a threshold voltage control circuit for adjusting operation threshold voltages of the AGC amplifier control circuit and the APD bias voltage control circuit.

An optical receiver according to another aspect of the present invention includes an APD for providing a current corresponding to an optical input intensity, an AGC amplifier for amplifying an output of the APD, a peak detecting circuit for detecting a peak of a signal output from the AGC amplifier and providing a voltage whose peak is detected to the AGC amplifier as a control voltage, a level shift circuit for shifting an output from the peak detecting circuit to a different level, and a bias voltage supplying circuit for supplying a bias voltage to the APD in accordance with an output from the level shift circuit.

An optical receiver according to still another aspect of the present invention includes an APD for providing a current corresponding to an optical input intensity, an AGC amplifier for amplifying an output of the APD, a peak detecting circuit for detecting a peak of a signal output from the AGC amplifier, an APD bias voltage supplying circuit for supplying a bias voltage to the APD based on an output from the peak detecting circuit, and a level shift circuit for shifting the output from the peak detecting circuit to a different level and supplying the shifted voltage to the AGC amplifier as a control voltage.

According to the present invention, the AGC amplifier control and the APD bias voltage control are simultaneously changed with respect to the optical input intensity, thereby allowing transition of the APD current to be approximately linear with respect to the optical input intensity, and an optical input intensity monitoring circuit operating in a wide range to be easily implemented.

### BRIEF DESCRIPTION OF THE DRAWINGS

FIG. 1 shows an optical receiver according to a first embodiment of the present invention.

FIG. 2 shows an optical receiver according to a second embodiment of the present invention.

FIG. 3 shows an optical receiver according to a third embodiment of the present invention.

FIG. 4 is a graph illustrating a relationship between an optical input intensity and a control voltage.

FIG. 5 is a graph illustrating a relationship between an optical input intensity and an APD current.

FIGS. 6A and 6B are graphs for describing operation in the first embodiment.

FIG. 7 shows an optical receiver according to a conventional example described in connection with the present invention.

### DESCRIPTION OF PREFERRED EMBODIMENTS

### First Embodiment

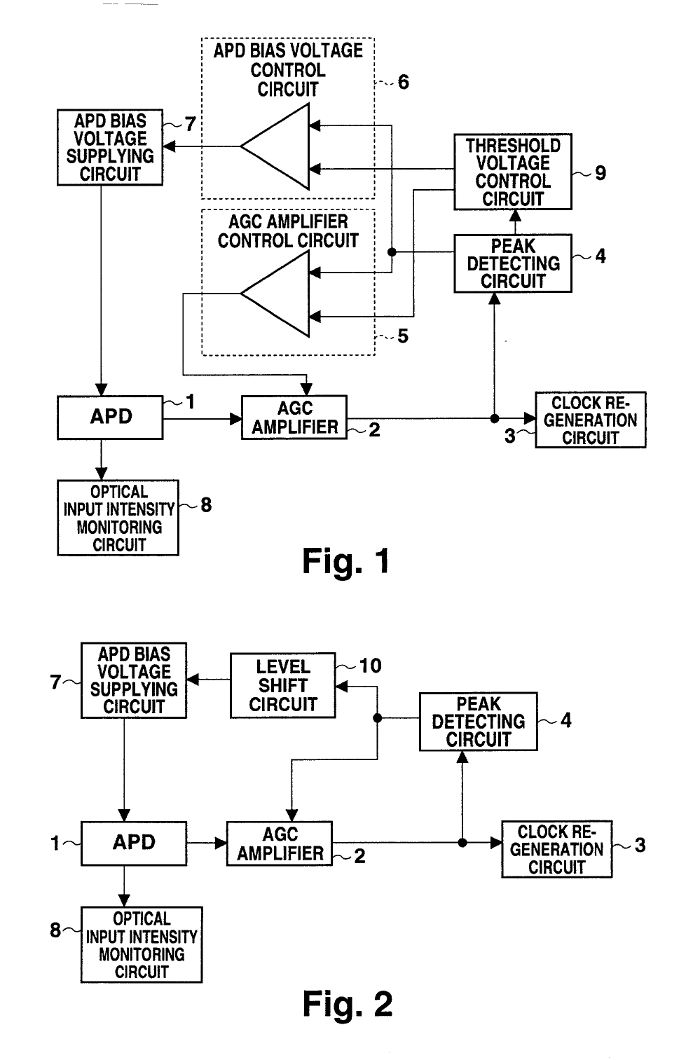

FIG. 1 shows a first embodiment of the present invention. Components identical to those in the above-described conventional circuit are labeled with the same reference numerals. In FIG. 1 is shown a threshold voltage control circuit 9 which controls operations of the AGC amplifier control circuit 5 and the APD bias voltage control circuit 6 so that these circuits 5, 6 operate in the same manner to achieve an approximately linear transition of the APD current with respect to the optical input intensity.

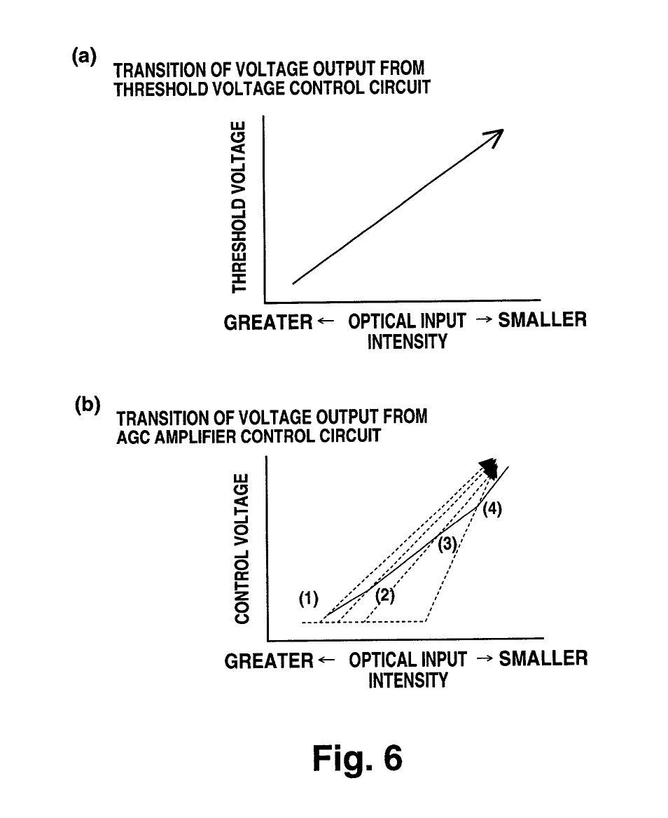

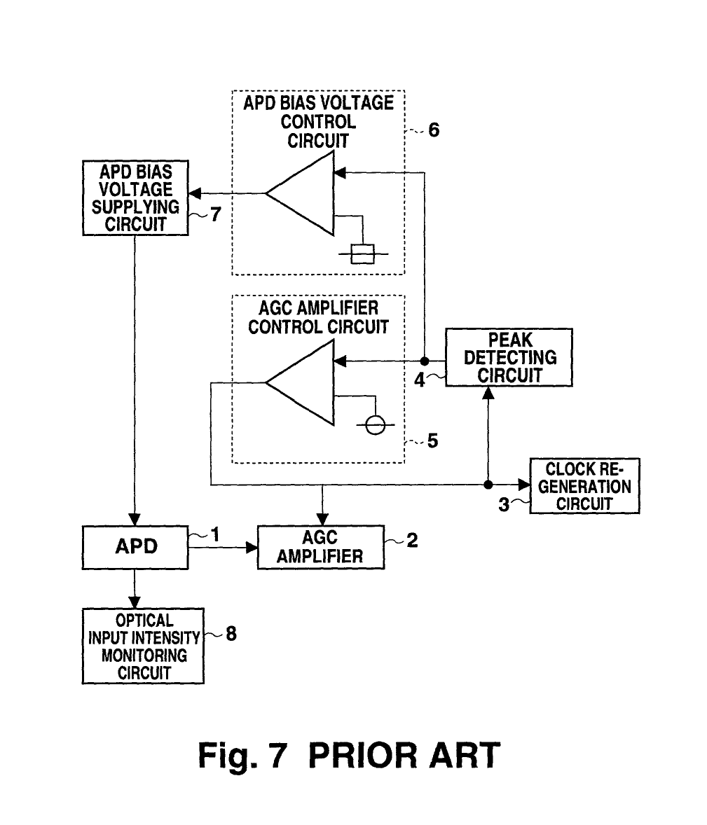

Operation of this embodiment will next be described. Conventional receivers suffer from a drawback that, when different operation threshold voltages are set for the AGC amplifier control circuit 5 and the APD bias voltage control circuit 6, the APD current starts to exhibit a non-linear transition with respect to the optical input intensity when the intensity reaches the switching point. In view of this problem, the threshold voltage control circuit 9 according to the present embodiment operates so as to control the operation threshold voltages of these control circuits, which have been fixed in conventional circuits, to optimum values for constantly achieving a linear transition of the APD current. That is, the threshold voltage control circuit 9 controls the AGC amplifier control system in a linear manner until the intensity reaches the control switching point as indicated by the line (a) in FIG. 4; after the control switching point and as indicated by the line (b) in FIG. 4, the APD bias control system assumes control and continues control in a linear manner. In this way, it is ensured that the systems always operate in a linear manner throughout the entire optical input range as indicated by a line (c) in FIG. 4. More specifically, the threshold voltage control circuit 9 outputs a continuous voltage exhibiting the transition shown in FIG. 6A based on the output from the peak detecting circuit 4. When the threshold voltage applied to the AGC amplifier control circuit 5 exhibits the transition shown in FIG. 6A, the voltage output from the AGC amplifier control circuit 5 shows a change with respect to the optical input intensity as indicated by the dotted lines in FIG. 6B. When the AGC control voltages are output as indicated by the dotted lines (1)-(4) at respective optical input intensities, a curve obtained by connecting these dotted lines will be close to the ideal voltage transition indicated by the line (c) in FIG. 4. By similarly controlling the APD bias voltage control circuit, the voltage transition with respect to the optical input intensity will be close to the ideal voltage transition indicated by the line (c) in FIG. 4.

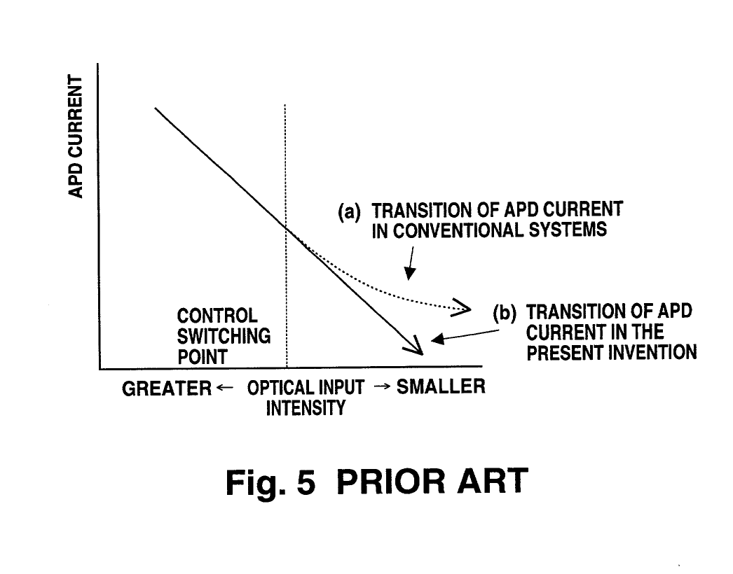

Throughout the above-described operation, an approximately linear transition of the APD current with respect to the optical input intensity can be achieved as indicated by the line (b) in FIG. 5 by simultaneously changing the AGC amplifier control and the APD bias voltage control with respect to the optical input intensity. As a result, the optical input intensity monitoring circuit 8 operating over a wide range can easily be implemented.

### Second Embodiment

FIG. 2 shows a second embodiment of the present invention. The components labeled with numerals 1-4, 7, and 8 are the same as those in the first embodiment described above. A level shift circuit 10 illustrated in FIG. 2 changes the voltage output from the peak detecting circuit 4 and applies the resulting voltage to the APD bias voltage supplying circuit 7, to thereby provide a difference between the AGC amplifier control voltage and the APD bias control voltage.

Operation will next be described. Because the output voltage of the peak detecting circuit 4 constantly changes with respect to the optical input intensity, by utilizing this output voltage for the AGC amplifier control voltage and the APD bias control voltage, the AGC amplifier control system and the APD bias voltage control system can operate in the manner indicated by the line (c) in FIG. 4. It should be noted that, generally, the AGC amplifier control voltage and the APD bias control voltage are set at different voltage levels to avoid cross interference, and the present embodiment makes it possible to achieve ideal operation of the control systems simply by adding a difference to the output voltage of the peak detecting circuit 4 so as to attain levels appropriate for the two voltages. More specifically, the output voltage of the peak detecting circuit 4 is directly used as the AGC amplifier control voltage, while the level shift circuit 10 is provided before the APD bias voltage supplying circuit 7, to thereby create a difference between the two control voltages. Such a circuit configuration causes the AGC amplifier control voltage and the APD bias control voltage to change in proportion to the output of the peak detecting circuit 4, and therefore to change simultaneously with respect to the optical input intensity.

Through the above-described operation, an approximately linear transition of the APD current with respect to the optical input intensity can be achieved, to thereby easily implement the optical input intensity monitoring circuit 8 operating over a wide range.

### Third Embodiment

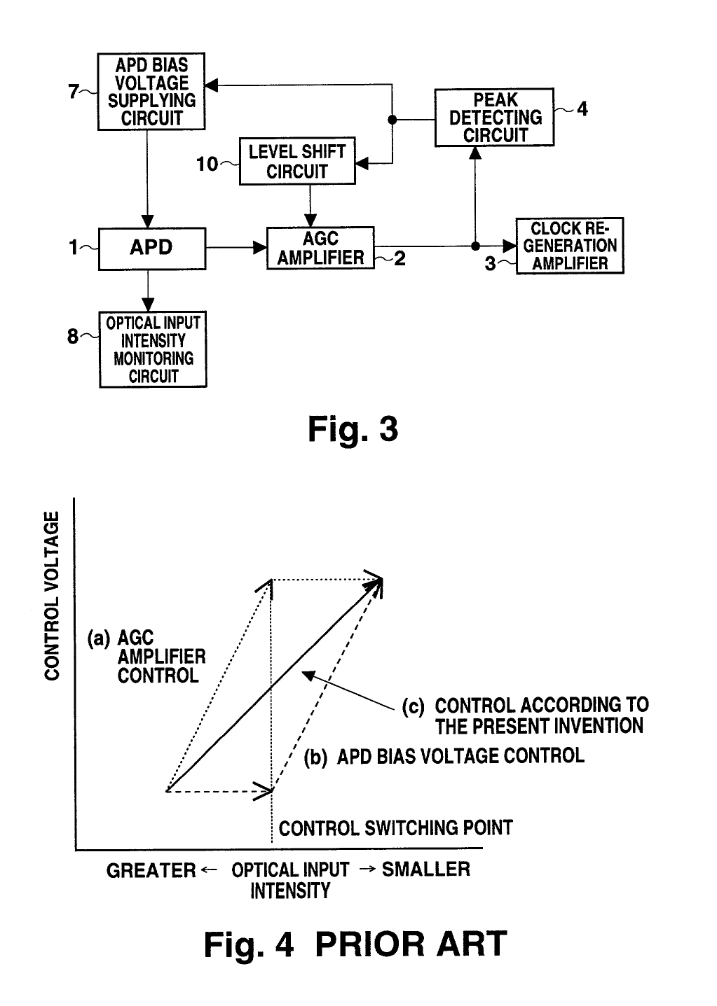

FIG. 3 shows a third embodiment of the present invention. The components 1-4, 7, and 8 are the same as those in the first and second embodiments described above. In FIG. 3 is shown a level shift circuit 10 which changes the voltage output from the peak detecting circuit 4 and applies the resulting voltage as the AGC amplifier control voltage to provide a difference between the AGC amplifier control voltage and the APD bias control voltage. In the present embodiment, the output voltage of the peak detecting circuit 4 is directly used as the APD bias control voltage, while the level shift circuit 10 is provided before the AGC amplifier 2 affecting the AGC amplifier control voltage, to thereby create a difference between the two control voltages. Such a circuit configuration causes the AGC amplifier control voltage and the APD bias control voltage to change in proportion to the output of the peak detecting circuit 4, and therefore to change simultaneously with respect to the optical input intensity.

Through the above-described operation, an approximately linear transition of the APD current with respect to the optical input intensity can be achieved, to thereby allow the optical input intensity monitoring circuit 8 operating over a wide range to be easily implemented.

What is claimed is:

1. An optical receiver, comprising:
an avalanche photo diode (APD) for providing a current corresponding to an optical input intensity;
an automatic gain control (AGC) amplifier for amplifying an output of said APD;
a peak detecting circuit for detecting a peak of a signal output from said AGC amplifier;
an AGC amplifier control circuit for adjusting a gain of said AGC amplifier based on an output from said peak detecting circuit;
an APD bias voltage control circuit for supplying a bias voltage to said APD based on the output from said peak detecting circuit; and
a threshold voltage control circuit for adjusting operation threshold voltages of said AGC amplifier control circuit and said APD bias voltage control circuit.

2. An optical receiver, comprising:
an APD for providing a current corresponding to an optical input intensity;
an AGC amplifier for amplifying an output of said APD;
a peak detecting circuit for detecting a peak of a signal output from said AGC amplifier and providing a voltage whose peak is detected to said AGC amplifier as a control voltage;
a level shift circuit for shifting an output from said peak detecting circuit to a different level; and
a bias voltage supplying circuit for supplying a bias voltage to said APD based on an output from said level shift circuit.

3. An optical receiver, comprising:
an APD for providing a current corresponding to an optical input intensity;
an AGC amplifier for amplifying an output of said APD;
a peak detecting circuit for detecting a peak of a signal output from said AGC amplifier;
an APD bias voltage supplying circuit for supplying a bias voltage to said APD based on an output from said peak detecting circuit; and
a level shift circuit for shifting the output from said peak detecting circuit to a different level and supplying the shifted voltage to the AGC amplifier as a control voltage.
